(19) United States
(12) Patent Application Publication
(10) Pub. No.: US 2012/0000258 A1
(43) Pub. Date: Jan. 5, 2012

(54) VEHICLE DOOR LOCKING DEVICE

(76) Inventors: Ryujiro Akizuki, Novi, MI (US); Takashi Nishio, Aichi-ken (JP); Yusuke Yamada, Aichi-ken (JP); Sho Sannohe, Aichi-ken (JP); Kazunori Kojima, Aichi-ken (JP)

(21) Appl. No.: 13/256,569

(22) PCT Filed: Mar. 25, 2010
(86) PCT No.: PCT/JP2010/055992

§ 371 Date: Sep. 14, 2011

(30) Foreign Application Priority Data
Apr. 23, 2009 (JP) 2009-105212

(51) Int. Cl. E05B 65/20

(52) U.S. Cl. 70/91

(57) ABSTRACT

A vehicle door locking device Ao is provided with an open mechanism A1, a lock mechanism A2, and an electric actuator A3, and also provided with a housing 10 accommodating these elements. An emergency operation member 42 manually operable from the indoor side of a door is assembled into the housing 10. A shaft portion 42a of the emergency operation member 42 is rotatably assembled into a support portion of the housing 10 instead of a key lock lever capable of driving by a mechanical key operation to a key cylinder positioned on the outer side of a vehicle.

### FIELD OF THE INVENTION

The present invention relates to a vehicle door locking device.

### BACKGROUND OF THE INVENTION

There is a vehicle door locking device provided with an open mechanism for actuating a latch mechanism from a latch state to an unlatch state in a manner that a vehicle door is openable relative to a vehicle body, a lock mechanism provided with an active lever capable of driving a lock/unlock member placed in the open mechanism to a locking position or an unlocking position, the lock mechanism for restraining or permitting an action of the open mechanism so as to lock or unlock the door, an electric actuator for driving the lock/unlock member to the locking position or the unlocking position through the active lever, and a housing accommodating the open mechanism, the lock mechanism, and the electric actuator, the vehicle door locking device being installed in the door. Such a device is shown in Japanese Patent Application Publication No. 2006-266026 for example.

There is another vehicle door locking device provided with elements corresponding to the open mechanism, the lock mechanism, the electric actuator, and the housing, and also provided with an emergency operation member assembled into the housing on the upper side of the latch mechanism. The emergency operation member is manually operable from the indoor side of the door, and is capable of driving the lock/unlock member from the unlocking position to the locking position through the active lever. Such a device is shown in Japanese Patent Application Publication No. 2001-241248 for example.

In the above vehicle door locking device described in Japanese Patent Application Publication No. 2006-266026, a key lock lever is adopted as a constituent part of the lock mechanism. The key lock lever is linked with a key cylinder provided on the outdoor side of the door and positioned on the outer side of the vehicle. The key lock lever is actuated by a mechanical operation (manual operation) to the key cylinder so as to drive the lock/unlock member from the unlocking position to the locking position through the active lever. Also, an operation lever is adopted as a constituent part of the lock mechanism. The operation lever is actuated by a manual operation of a lock knob provided on the indoor side of the door, so as to drive the lock/unlock member from the unlocking position to the locking position through the active lever. Therefore, in the vehicle door locking device, even at the time of emergency (for example, when the electric actuator is temporarily not actuated due to run-out of a battery or the like), the lock/unlock member can be driven from the unlocking position to the locking position through the active lever by the mechanical key operation (manual operation) to the key cylinder or the manual operation of the lock knob.

Meanwhile, in the above vehicle door locking device described in Japanese Patent Application Publication No. 2001-241248, although elements corresponding to the key lock lever and the operation lever are not provided, the emergency operation member, which is manually operable from the indoor side of the door, and is capable of driving the lock/unlock member from the unlocking position to the locking position through the active lever, is provided. Thus, even at the time of emergency, by manually operating the emergency operation member, the lock/unlock member can be driven from the unlocking position to the locking position through the active lever.

### SUMMARY OF THE INVENTION

In the above vehicle door locking device described in Japanese Patent Application Publication No. 2006-266026 and the above vehicle door locking device described in Japanese Patent Application Publication No. 2001-241248, basic functional parts such as the open mechanism, the lock mechanism, and the electric actuator can be shared. However, there is a difference regarding that the door locking device has the key lock lever and the operation lever, or the emergency operation member. Therefore, a shape of the housing in the vehicle door locking device provided with the key cylinder and a shape of the housing in the vehicle door locking device provided with no key cylinder but another emergency operation member are totally different from each other. Thus, an object of the present invention is to provide a vehicle door locking device in which a shape of a housing is not greatly influenced by placement of a key cylinder and an emergency operation member.

The present invention is achieved in order to solve the above problem, and characterized by a vehicle door locking device, including an open mechanism for actuating a latch mechanism from a latch state to an unlatch state in a manner that a vehicle door is openable relative to a vehicle body, a lock mechanism provided with an active lever capable of driving a lock/unlock member placed in the open mechanism to a locking position or an unlocking position, the lock mechanism for restraining or permitting an action of the open mechanism so as to lock or unlock the door, an electric actuator for driving the lock/unlock member to the locking position or the unlocking position through the active lever, a housing accommodating the open mechanism, the lock mechanism, and the electric actuator, an emergency operation member assembled into the housing on the upper side of the latch mechanism, the emergency operation member being manually operable from the indoor side of the door, the emergency operation member being capable of driving the lock/unlock member from the unlocking position to the locking position through the active lever, and a support portion set in the housing, the support portion being capable of supporting any one of a key lock lever linked with a key cylinder positioned on the outer side of the vehicle, the key lock lever being capable of driving the active lever by a mechanical key operation to the key cylinder, and the emergency operation member positioned on the inner side of the vehicle instead of the key lock lever.

In this case, the support portion may be provided with a guide portion protruding toward the outer side of the vehicle from a part on the outer side of the vehicle in a manner that a curved surface for guiding a coupling shaft which transmits operation force of the key cylinder and is linked with the key lock lever is formed. The housing may be provided with a housing body facing the outdoor side in the door, and a housing cover assembled to the housing body, the housing cover facing the indoor side in the door, and the support portion may be formed as any one of an attachment hole formed in the housing cover, the attachment hole rotatably supporting the emergency operation member, and an attachment hole formed in the housing body, the attachment hole rotatably supporting the key lock lever.

The housing may be provided with a housing body facing the outdoor side in the door, and a housing cover assembled to the housing body, the housing cover facing the indoor side in the door, and the support portion may be formed as any one of an attachment hole formed in the housing cover, the attachment hole rotatably supporting the emergency operation member, and an attachment hole formed in the housing body, the attachment hole communicating with the guide portion and rotatably supporting the key lock lever.

The emergency operation member may have a shaft portion rotatably supported by the attachment hole formed in the housing cover, and an end surface of the shaft portion may be exposed outside the housing. The key lock lever may be rotatably supported by the attachment hole of the housing body through an outside locking lever rotatably supported by the attachment hole formed in the housing body, and an end surface of the outside locking lever may be exposed outside the housing.

In the vehicle door locking device according to the present invention, the support portion provided in the housing can support the emergency operation member instead of the key lock lever. Therefore, when the emergency operation member is supported by the support portion provided in the housing, at the time of emergency (for example, when the electric actuator is temporarily not actuated due to run-out of a battery or the like), the lock/unlock member can be driven from the unlocking position to the locking position through the active lever by a manual operation of the emergency operation member.

In the vehicle door locking device according to the present invention, the support portion provided in the housing can support the key lock lever linked with the key cylinder (for example, provided on the outdoor side of a front passenger seat door). The key lock lever is capable of driving the active lever by the mechanical key operation to the key cylinder. Therefore, when the key lock lever is supported by the support portion provided in the housing, and the key cylinder is linked with the key lock lever, the key lock lever can be actuated by the mechanical key operation (manual operation) to the key cylinder, so that the lock/unlock member can be driven from the unlocking position to the locking position through the active lever.

In the vehicle door locking device according to the present invention, the support portion capable of supporting the key lock lever linked with the key cylinder which is capable of driving the active lever by the mechanical key operation to the key cylinder, or the emergency operation member instead of the key lock lever, is set in the housing of the vehicle door locking device. Therefore, when the emergency operation member is supported by the support portion provided in the housing, the housing can serve as a housing of a preferred door locking device for a door provided with no key cylinder and no lock knob (such as the front passenger seat door provided with the emergency operation member). Meanwhile, when the key lock lever is supported by the support portion provided in the housing, the housing can serve as a housing of a preferred door locking device for a door provided with the key cylinder (such as the front passenger seat door provided with the key cylinder).

Therefore, a shape of the housing is not greatly influenced by placement (adoption) of the key cylinder and the emergency operation member. Thus, for example, by making parts other than the support portion of the housing have the same shape, and partly changing a shape of the support portion by using a slide die (one constituent member of a resin molding die for the housing), irrespective of a difference in the adoption of the key cylinder and the emergency operation member, the housing can be made by the substantially same resin molding die, so that cost of the door locking device can be reduced.

### BRIEF DESCRIPTION OF THE DRAWINGS

FIG. 1 is a perspective view schematically showing a state that a vehicle door locking device according to the present invention is installed in a right front passenger seat door provided with no key cylinder and no lock knob;

FIG. 2 is a side view of the vehicle door locking device shown in FIG. 1 on the indoor side;

FIG. 3 is a side view of the vehicle door locking device shown in FIG. 1 on the outdoor side;

FIG. 4 is a structural view of major parts in an unlock state of the vehicle door locking device shown in FIGS. 2 and 3;

FIG. 5 is a structural view of the major parts in a lock state of the vehicle door locking device shown in FIGS. 2 and 3;

FIG. 6 is an exploded perspective view of part of an open mechanism and a latch mechanism in the vehicle door locking device shown in FIGS. 1 to 5;

FIG. 7 is an exploded perspective view of the open mechanism, a lock mechanism, and an electric actuator in the vehicle door locking device shown in FIGS. 1 to 5;

FIG. 8 is a sectional view along the line 8-8 in FIG. 3;

FIG. 9 is a sectional view corresponding to FIG. 8, the view showing another embodiment of the vehicle door locking device according to the present invention;

FIG. 10 is an exploded perspective view corresponding to FIG. 7 in a case where a vehicle door locking device to be installed in a right front passenger seat door provided with a key cylinder and a lock knob is formed based on the vehicle door locking device of an embodiment shown in FIGS. 1 to 8; and

FIG. 11 is a sectional view corresponding to FIG. 8, the view showing the vehicle door locking device shown in FIG. 10.

### DETAILED DESCRIPTION OF THE INVENTION

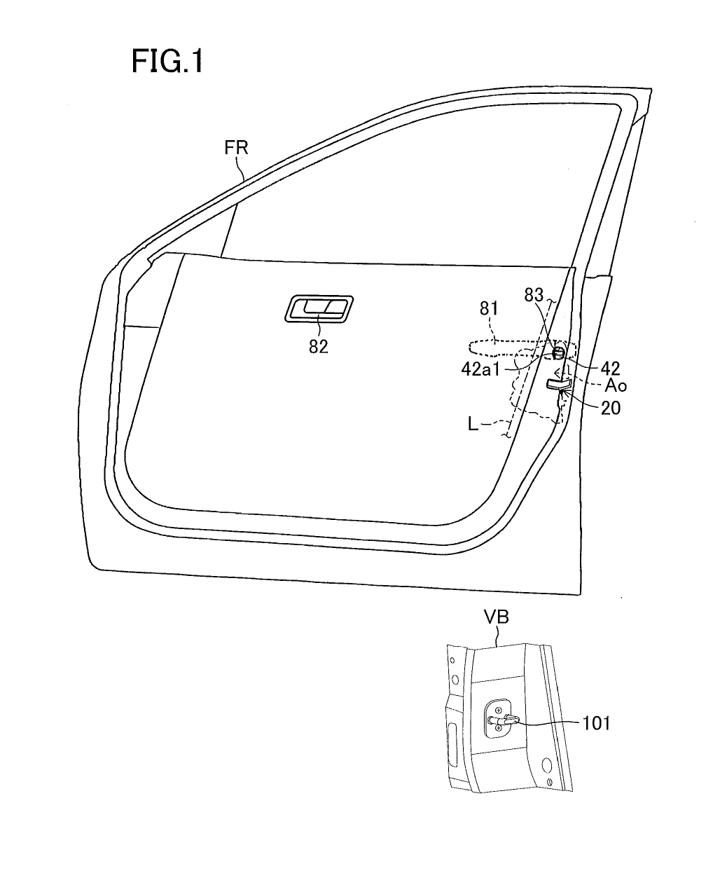

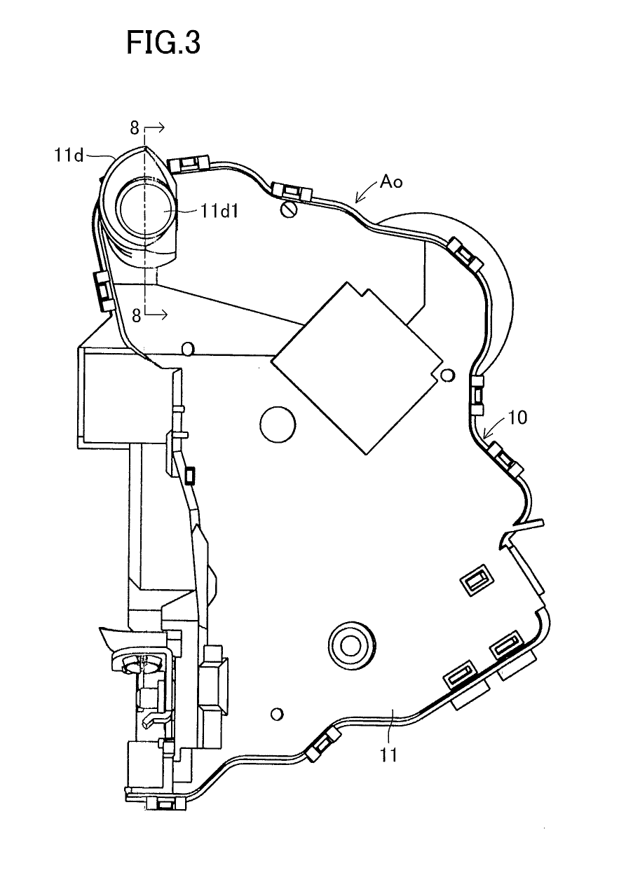

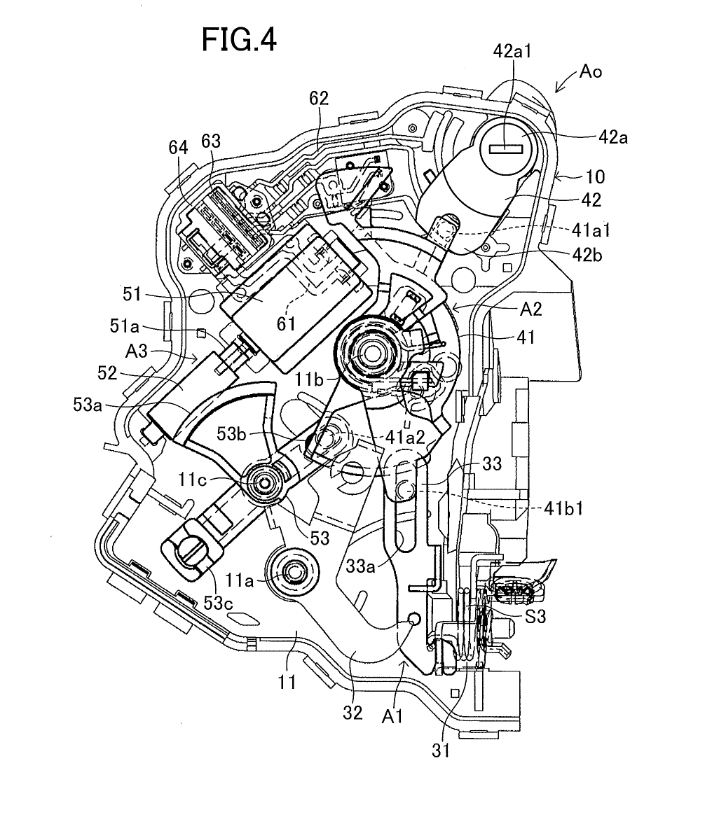

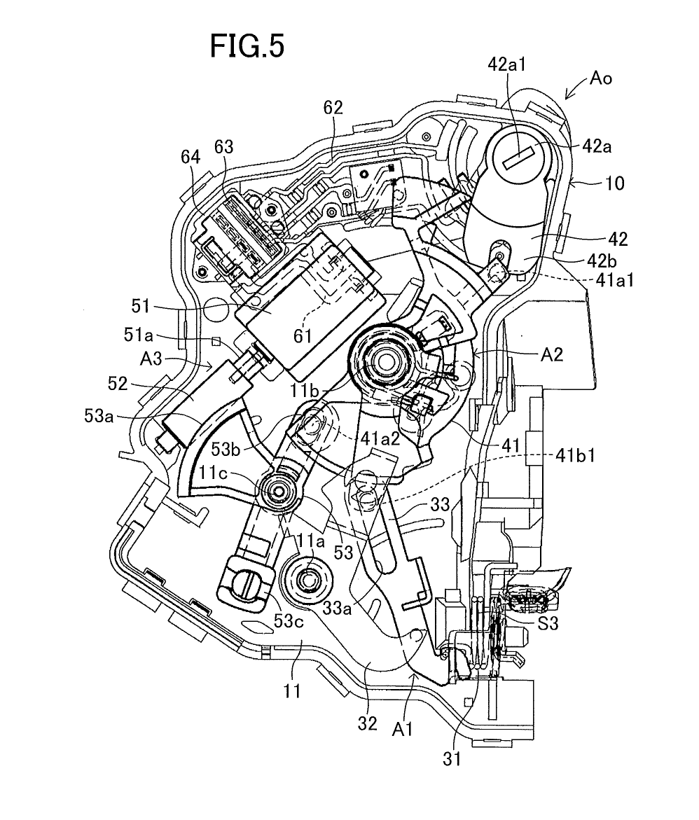

Hereinafter, an embodiment of the present invention will be described based on the drawings. FIGS. 1 to 8 show a vehicle door locking device Ao according to the present invention. The vehicle door locking device Ao is installed in a right front passenger seat door FR (refer to FIG. 1) mounted on the front right side of a vehicle. As shown in FIGS. 4 and 5, the vehicle door locking device Ao is provided with an open mechanism A1, a lock mechanism A2, and an electric actuator A3, and also provided with a housing 10 accommodating the open mechanism A1, the lock mechanism A2, and the electric actuator A3.

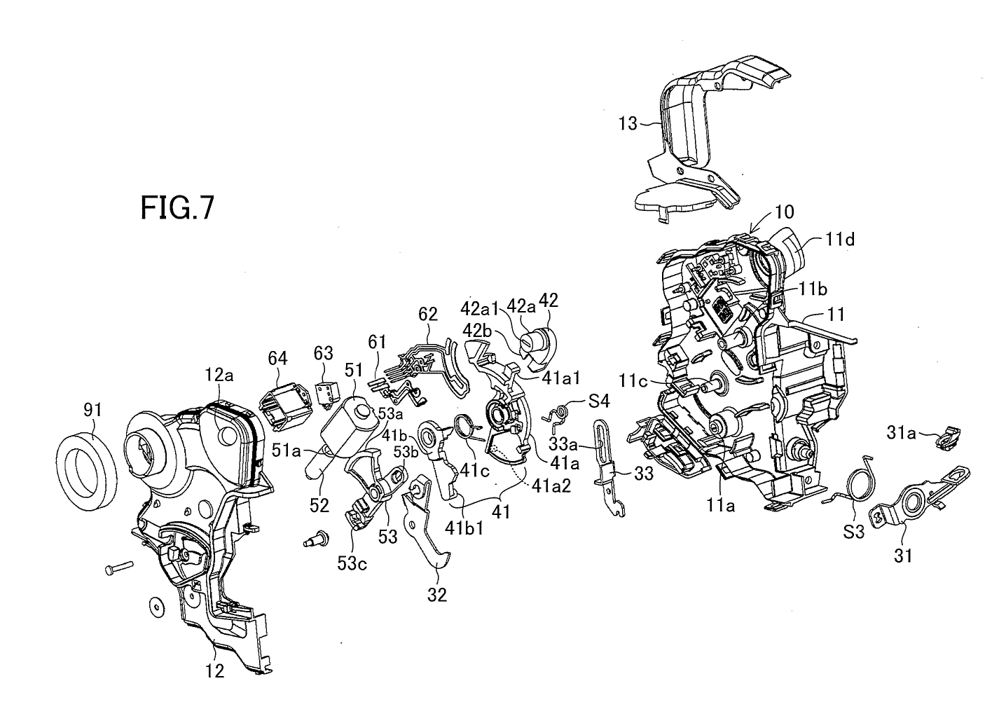

As shown in FIG. 7, the housing 10 is provided with a resin housing body 11, a resin housing cover 12 assembled to the housing body 11, and a resin protector 13 assembled to the housing body 11 and the housing cover 12. These elements are respectively formed by molding with using a resin molding die. The housing body 11 is arranged so as to face the outdoor side in the door FR. Meanwhile, the housing cover 12 is arranged so as to face the indoor side in the door FR. It should be noted that a seal ring 91 is assembled into the housing cover 12.

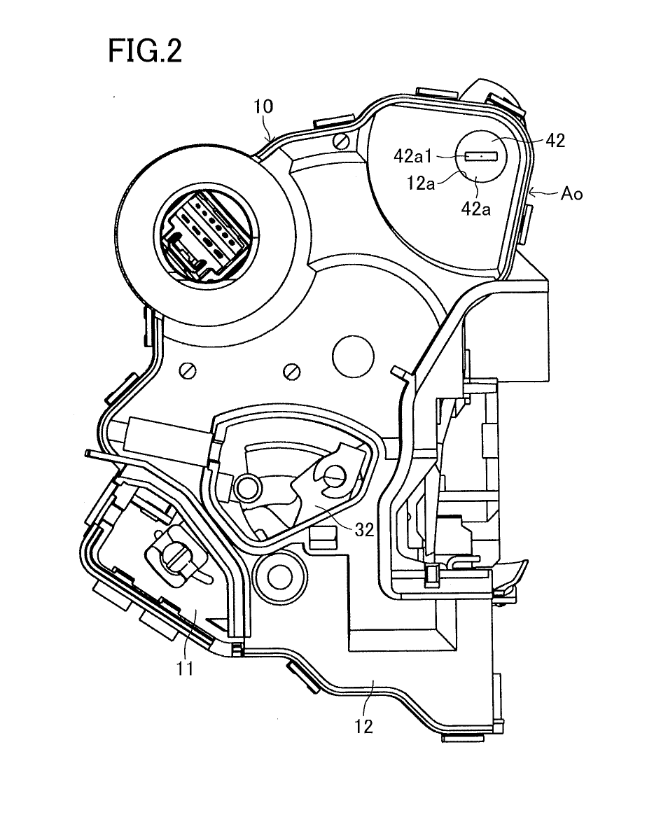

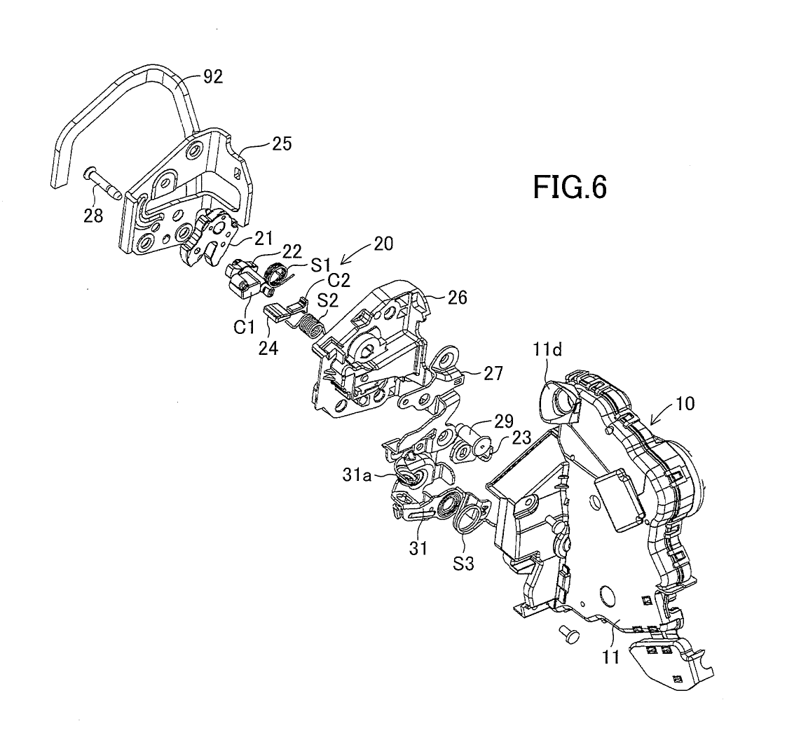

The open mechanism A1 is to actuate a known latch mechanism 20 (refer to FIG. 6) from a latch state to an unlatch state in a manner that the right front passenger seat door FR of the vehicle is openable relative to a vehicle body VB (refer to FIG. 1). The latch mechanism 20 is to retain the right front passenger seat door FR in a closed state relative to the vehicle body VB (state that the door is closed). The latch mechanism 20 is provided with a latch 21 engageable with and disengageable from a striker 101 (refer to FIG. 1) fixed to the vehicle body VB. It should be noted that the latch mechanism 20 is not shown in FIGS. 2 to 5 but shown in an exploded state in FIG. 6, and assembled into the right front passenger seat door FR in a state that the latch mechanism 20 is assembled into the housing 10 (state that the latch mechanism 20 is integrated with the open mechanism A1, the lock mechanism A2, the electric actuator A3, and the like).

The latch mechanism 20 is engaged with the striker 101 so as to retain the right front passenger seat door FR in the closed state (latch state). With the right front passenger seat door FR in the closed state, the latch mechanism 20 is disengaged from the striker 101, so that the right front passenger seat door FR is switched from the closed state to an opened state (state that the right front passenger seat door FR is openable relative to the vehicle body VB) (unlatch state). As shown in FIG. 6, the latch mechanism 20 is provided with the latch 21, a pole 22, a lift lever 23, and a stopper 24, and also provided with cushions C1, C2, a latch torsion spring S1, and a pole torsion spring S2. These constituent parts are assembled into a base plate 25, a case 26, and a sub base plate 27 with using a screw 28 and a pin 29. It should be noted that the base plate 25 is assembled into the right front passenger seat door FR through a seal member 92.

The open mechanism A1 is provided with an outside open lever 31, an inside open lever 32, and an open link 33 (lock/unlock member of the present invention). The outside open lever 31 is assembled into the housing body 11 together with a torsion spring S3. The outside open lever 31 is linked with an outside handle 81 (refer to FIG. 1) provided on the outdoor side of the right front passenger seat door FR, and actuated by operating the outside handle 81. It should be noted that a clip 31a (refer to FIGS. 6 and 7) is assembled into the outside open lever 31.

The inside open lever 32 is rotatably assembled to a support shaft 11a provided in the housing body 11. The inside open lever 32 is linked with an inside handle 82 (refer to FIG. 1) provided on the indoor side of the right front passenger seat door FR, and actuated by operating the inside handle 82. The open link 33 is movably coupled to and supported on the outside open lever 31 at a lower end thereof. The open link 33 is movable between an unlock position shown in FIG. 4 and a lock position shown in FIG. 5 by an active lever 41 serving as a constituent part of the lock mechanism A2. When the open link 33 is in the unlock position shown in FIG. 4, the open link 33 can engage with the lift lever 23 of the latch mechanism 20 to open the right front passenger seat door FR. When the open link 33 is in the lock position shown in FIG. 5, the open link 33 can not engage with the lift lever 23 of the latch mechanism 20.

The open link 33 is moved from the positions shown in FIGS. 4 and 5 in the upward direction of the device (toward the upper side in FIGS. 4 and 5) upon receiving an action of the outside open lever 31 (operation of the outside handle 81) or receiving an action of the inside open lever 32 (operation of the inside handle 82). Therefore, in a case where the open link 33 at the unlock position shown in FIG. 4 is moved in the upward direction upon receiving the action of the outside open lever 31 or the inside open lever 32 when the right front passenger seat door FR is in the closed state, the lift lever 23 of the latch mechanism 20 is pushed by the open link 33 and rotated, so that the latch mechanism 20 is actuated from the latch state to the unlatch state. Thereby, the right front passenger seat door FR is switched from the closed state to the opened state. That is, when the open link 33 is at the unlock position in FIG. 4, the right front passenger seat door FR is unlocked.

Meanwhile, in a case where the open link 33 at the lock position shown in FIG. 5 is moved in the upward direction upon receiving the action of the outside open lever 31 or the inside open lever 32 when the right front passenger seat door FR is in the closed state, the open link 33 is not engaged with the lift lever 23 of the latch mechanism 20, so that the latch mechanism 20 is maintained in the latch state. Thereby, the right front passenger seat door FR is maintained in the closed state. That is, when the open link 33 is at the lock position in FIG. 5, the right front passenger seat door FR is locked.

The lock mechanism A2 is to restrain or permit an action of the open mechanism A1 so as to lock or unlock the door. The lock mechanism A2 is provided with the above active lever 41, and also provided with an emergency operation member 42 capable of driving the above open link 33 from the unlock position to the lock position (from the unlocking position to the locking position) through the active lever 41.

The active lever 41 is assembled to a support shaft 11b provided in the housing body 11 together with a torsion spring S4 (refer to FIG. 7), and rotatably supported on the support shaft 11b. As shown in FIG. 7, the active lever 41 is provided with a main lever 41a, a sub lever 41b, and a twisted spring 41c. The main lever 41a is rotatably assembled to the support shaft 11b. The main lever 41a has an engagement portion (pin portion) 41a1 linked with the emergency operation member 42, and also has an engagement portion (pin portion) 41a2 linked with the electric actuator 43. The sub lever 41b is rotatably assembled to the support shaft 11b, and rotatable relative to the main lever 41a by a predetermined amount. The sub lever 41b has an engagement portion (pin portion) 41b1 linked with a long hole 33a of the open link 33.

The twisted spring 41c (bias member) is placed between the main lever 41a and the sub lever 41b as well as the twisted spring described in Japanese Patent Application Publication No. 2006-266026 to rotate and bias the sub lever 41b in one direction (anti-clockwise direction in the figure) relative to the main lever 41a. Therefore, the main lever 41a and the sub lever 41b are integrally rotated in the clockwise direction in the figure (lock direction), and rotated through the twisted spring 41c in the unlock direction.

The emergency operation member 42 has a shaft portion 42a rotatably assembled into the housing 10 on the upper side of the latch mechanism 20, and also has a lever portion 42b engaged with the engagement portion 41a1 of the main lever 41a in the active lever 41. The shaft portion 42a is rotatably supported by an attachment hole 12a formed in the housing cover 12 and provided so that an end surface thereof is exposed outside the housing 10. An I-shape groove 42a1 is formed in the shaft portion 42a. A tool (such as a slotted screwdriver) or a mechanical key (key plate for operating a key cylinder and the like) can be inserted into the I-shape groove 42a1 through a tool insertion hole 83 (refer to FIG. 1) provided on the inner side of the right front passenger seat door FR. Thus, in a state that the right front passenger seat door FR is opened, the emergency operation member 42 is manually operable (rotatable) from the indoor side of the door FR.

Therefore, in a state that the right front passenger seat door FR is opened, when the emergency operation member 42 is rotated with using the tool or the mechanical key, the active lever 41 is rotated. By transmitting the rotation of the active lever 41 to the open link 33, the door can be locked. It should be noted that the shaft portion 42a may be configured in such a way as to be directly operated and rotated without providing the I-shape groove 42a1 in the shaft portion 42a of the emergency operation member 42.

The electric actuator A3 drives the above open link 33 to the lock position or the unlock position through the active lever 41. The electric actuator A3 is provided with an electric motor 51, a worm 52, and a locking lever 53. The electric motor 51 is a known motor driven in accordance with a lock operation and an unlock operation, and a first terminal 61, a second terminal 62, a switch 63, a connector 64, and the like are provided for controlling an action thereof. The worm 52 is provided integrally with an output shaft 51a of the electric motor 51, and rotated and driven by the electric motor 51. The locking lever 53 is rotatably assembled to a support shaft 11c provided in the housing body 11.

The locking lever 53 has a sector gear 53a meshed with the worm 52, and also has an engagement portion (long hole) 53b linked with the engagement portion (pin portion) 41a2 of the main lever 41a in the active lever 41. Therefore, when the electric actuator A3 is actuated, the locking lever 53 is tilted by drive force of the electric motor 51. In accordance with the tilting of the locking lever 53, the active lever 41 is rotated. When the rotation of the active lever 41 is transmitted to the open link 33, the door is locked or unlocked. It should be noted that in this embodiment, a formation angle of the sector gear 53a is substantially 45 degrees, so that an action response property in a case where the electric actuator A3 is actuated (time required for switching between lock and unlock of the door) is improved in comparison to an action response property of the electric actuator described in Japanese Patent Application Publication No. 2006-266026.

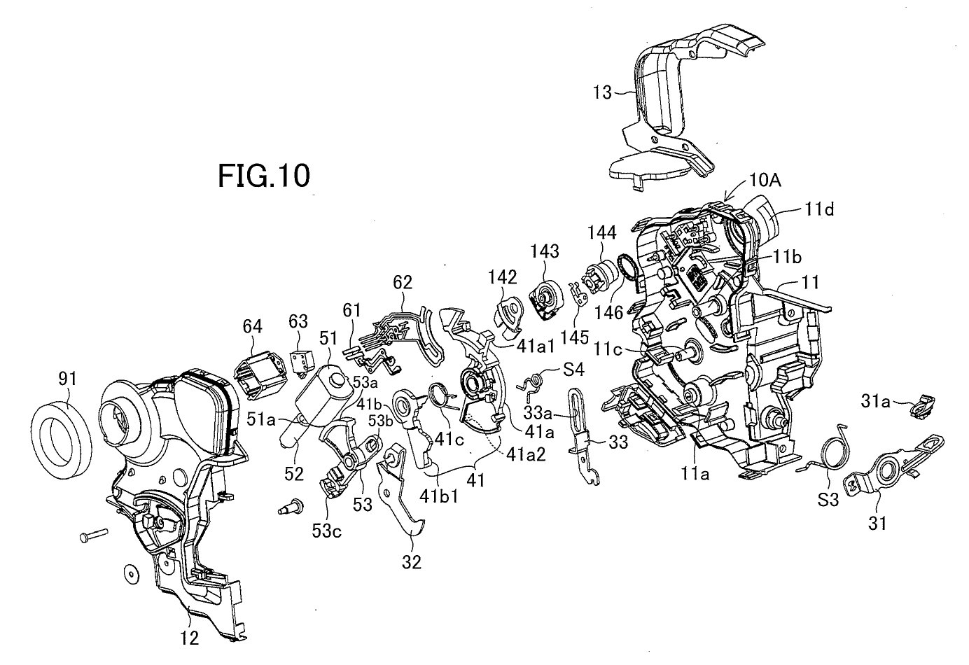

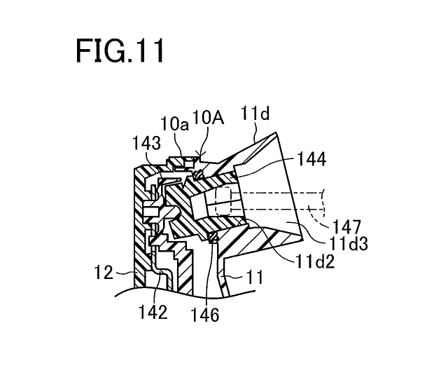

In this embodiment, an operation portion 53c is provided in the locking lever 53. However, since a lock knob is not provided on the indoor side of the right front passenger seat door FR in this embodiment, the lock knob is not linked with the operation portion 53c. It should be noted that in the case where the operation portion 53c is tilted integrally with the engagement portion 53b irrespective of a position of the sector gear 53a, and the door locking device Ao is provided with the lock knob on the indoor side of the door and applied to the right front passenger seat door provided with the key cylinder on the outdoor side of the door (in this case, as shown in FIGS. 10 and 11, instead of the emergency operation member 42, a key lock lever 142 is assembled into a housing 10A together with a key switch lever 143, an outside locking lever 144, a contact 145, a seal ring 146, and the like, and linked with the key cylinder through a coupling shaft 147), the operation portion 53c is linked with the lock knob provided on the indoor side of the right front passenger seat door. Therefore, in such a case, when the lock knob is operated and the operation portion 53c is tilted, the engagement portion 53b of the locking lever 53 is integrally tilted, so that the active lever 41 is rotated. When the rotation of the active lever 41 is transmitted to the open link 33, the door is locked or unlocked.

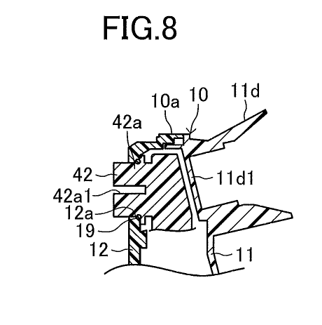

In the above vehicle door locking device Ao, as shown in FIG. 8, instead of the key lock lever 142 (refer to FIGS. 10 and 11), the emergency operation member 42 is rotatably supported by a support portion 10a provided in the housing 10 (in detail, the attachment hole 12a of the housing cover 12 cited in FIGS. 7 and 8) through a seal ring 19. Thus, at the time of emergency (for example, when the electric actuator A3 is temporarily not actuated due to run-out of a battery or the like), the open link 33 can be driven from the unlocking position to the locking position through the active lever 41 by a manual operation of the emergency operation member 42. Therefore, the door locking device Ao can serve as a preferable door locking device for the right front passenger seat door FR (door provided with no key cylinder and no lock knob capable of driving the open link 33 to the locking position or the unlocking position from the inside/outside of the vehicle through the active lever 41).

In the above vehicle door locking device Ao, instead of provision of the attachment hole 12a in the housing cover 12, the key lock lever 142 capable of driving the active lever 41 can be supported together with the key switch lever 143, the outside locking lever 144, the contact 145, the seal ring 146, and the like by the support portion 10a of the housing 10A in FIGS. 10 and 11 in which a bottom wall 11d1 (refer to FIG. 8) of a guide portion 11d provided in the housing body 11 is removed so as to form an attachment hole 11d2. It should be noted that in the support portion 10a of the housing 10A shown in FIGS. 10 and 11, the attachment hole 12a is not provided in the housing cover 12. The key lock lever 142 is rotatable in accordance with rotation of the key switch lever 143 and the outside locking lever 144. The outside locking lever 144 is rotatably supported by the attachment hole 11d2 formed in the housing body 11, and provided so that an end surface thereof is exposed outside the housing 10A.

Therefore, as shown in FIG. 11, when the key lock lever 142, the key switch lever 143, and the outside locking lever 144 are rotatably supported by the support portion 10a (in detail, the attachment hole 11d2 communicating with the guide portion 11d) provided in the housing 10A, and the key cylinder (provided on the outdoor side of the right front passenger seat door) is linked with the outside locking lever 144 through the coupling shaft 147, the key lock lever 142 is actuated through the coupling shaft 147, the outside locking lever 144, and the key switch lever 143 by a mechanical key operation (manual operation) to the key cylinder, so that the open link 33 can be driven from the unlocking position to the locking position through the active lever 41. Thus, the door locking device Ao can serve as a preferable door locking device for the right front passenger seat door provided with the key cylinder.

The above coupling shaft 147 is placed between the key cylinder (provided in the vicinity of the outside handle 81 shown in FIG. 1) and the outside locking lever 144, and linked with the key lock lever 142 through the outside locking lever 144 and the key switch lever 143, so as to transmit operation force of the key cylinder to the outside locking lever 144. At the time of being coupled to the outside locking lever 144, the coupling shaft 147 is guided by a curved surface 11d3 formed in the guide portion 11d protruding toward the outer side of the vehicle from a part on the outer side of the vehicle.

In the housing 10 of the above vehicle door locking device Ao, the support portion 10a capable of supporting the key lock lever 142 and the like (refer to FIGS. 10 and 11), or capable of supporting the emergency operation member 42 (refer to FIG. 8) instead of the key lock lever 142 and the like is set. Therefore, when the emergency operation member 42 is supported by the support portion 10a provided in the housing 10 (specifically when the attachment hole 12a is provided in the housing cover 12), the housing 10 can serve as a housing of a preferable door locking device for the right front passenger seat door FR provided with no key cylinder and no lock knob. When the key lock lever 142 and the like are supported by the support portion 10a provided in the housing 10A (specifically when, instead of the provision of the attachment hole 12a in the housing cover 12, the bottom wall 11d1 of the guide portion 11d provided in the housing body 11 is removed so as to form the attachment hole 11d2), the housing 10A can serve as a housing of a preferable door locking device for the door provided with the key cylinder (for example, the front passenger seat door provided with the key cylinder).

Therefore, a shape of the housing 10 (10A) is not greatly influenced by placement (adoption) of the key cylinder and the emergency operation member 42. Thus, for example, by making parts other than the support portion 10a of the housing 10 (10A) have the same shape, and partly changing a shape of the support portion 10a by using a slide die (one constituent member of a resin molding die for the housing), irrespective of a difference in the adoption of the key cylinder and the emergency operation member 42, the housing 10 (10A) can be made by the substantially same resin molding die, so that cost of the door locking device can be reduced.

In the above vehicle door locking device Ao, as shown in FIG. 1, the emergency operation member 42 is rotatably assembled into the housing 10 on the upper side of the latch mechanism 20. Thus, a part L of a seal line set in the right front passenger seat door FR on the front side of the latch mechanism 20 (the seal line being set in a part where a seal member assembled on the vehicle body side for waterproofing is abutted with the inner side of the right front passenger seat door FR when the right front passenger seat door FR is closed, and set on the front side of the latch mechanism 20 by a predetermined amount at a point where the latch mechanism 20 is provided) is not overlapped with the tool insertion hole 83 provided on the inner side of the right front passenger seat door FR. It should be noted that in a case where instead of the emergency operation member 42, the key lock lever 142 and the like are assembled to the support portion 10a of the housing, the key cylinder provided on the outdoor side of the door is arranged at a position determined based on a position of the outside handle 81, the position being away from the above seal line.

In the above vehicle door locking device Ao, the tilting of the locking lever 53 having the sector gear 53a is transmitted to the active lever 41. Thus, by appropriately setting an arm length of the locking lever 53 (arm length up to the engagement portion (pin portion) 41a2 of the main lever 41a in the active lever 41), a freedom degree of arrangement of the locking lever 53 can be increased, and a freedom degree of arrangement of the electric motor 51 and the worm 52 can also be increased. The arm length of the locking lever 53 is not restricted by size of the sector gear 53a but can be appropriately set. Thus, a desired reduction ratio can be obtained between the locking lever 53 and the active lever 41. Thereby, downsizing of the door locking device Ao can be achieved.

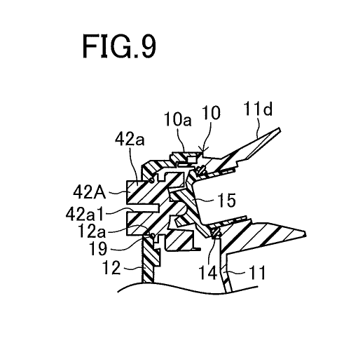

In the above embodiment, as shown in FIG. 8, the emergency operation member 42 is rotatably assembled into the attachment hole 12a of the housing cover 12 in the housing 10 (support portion 10a of the housing 10). However, as shown in FIG. 9, an emergency operation member 42A can be also rotatably assembled into the housing cover 12 of the housing 10 and a support cap 15 assembled into the housing body 11 of the housing 10 through a seal ring 14 (support portion 10a of the housing 10). It should be noted that in the embodiment shown in FIG. 9, instead of the seal ring 14 and the support cap 15, the seal ring 146 and the outside locking lever 144 shown in FIGS. 10 and 11 can also be adopted. It should be noted that the emergency operation member 42A in FIG. 9 has a shaft portion 42a and a lever portion (not shown) as well as the emergency operation member 42 in FIG. 8, and an I-shape groove 42a1 is formed in the shaft portion 42a.

In the above embodiment, a case where the vehicle door locking device according to the present invention is installed in the right front passenger seat door provided with no key cylinder (and no lock knob) (left-hand drive vehicle in which a left front seat is a driver seat) is described. However, the vehicle door locking device according to the present invention can also be applied to a left front passenger seat door provided with no key cylinder (and no lock knob) (passenger seat door in a right-hand drive vehicle in which a right front seat is a driver seat) as well as the above embodiment. The present invention can also be applied to a vehicle rear door in a case where a type provided with a key cylinder (and a lock knob) and a type provided with an emergency operation member instead of the key cylinder (and the lock knob) are set as well as the above embodiment. It should be noted that, although the vehicle door locking device provided with the key cylinder and also provided with the lock knob is described in the above embodiment, the vehicle door locking device of the present invention can be applied to the door locking device provided with the key cylinder and provided with no lock knob.

1. A vehicle door locking device, comprising:
an open mechanism for actuating a latch mechanism from a latch state to an unlatch state in a manner that a vehicle door is openable relative to a vehicle body;
a lock mechanism provided with an active lever capable of driving a lock/unlock member placed in the open mechanism to a locking position or an unlocking position, the lock mechanism for restraining or permitting an action of the open mechanism so as to lock or unlock the door;
an electric actuator for driving the lock/unlock member to the locking position or the unlocking position through the active lever;
a housing accommodating the open mechanism, the lock mechanism, and the electric actuator;
an emergency operation member assembled into the housing on the upper side of the latch mechanism, the emergency operation member being manually operable from the indoor side of the door, the emergency operation member being capable of driving the lock/unlock member from the unlocking position to the locking position through the active lever; and
a support portion set in the housing, the support portion being capable of supporting any one of a key lock lever linked with a key cylinder positioned on the outer side of the vehicle, the key lock lever being capable of driving the active lever by a mechanical key operation to the key cylinder, and the emergency operation member positioned on the inner side of the vehicle instead of the key lock lever.

2. The vehicle door locking device according to claim 1, wherein the support portion is provided with a guide portion protruding toward the outer side of the vehicle from a part on the outer side of the vehicle in a manner that a curved surface for guiding a coupling shaft which transmits operation force of the key cylinder and is linked with the key lock lever is formed.

3. The vehicle door locking device according to claim 1, wherein
the housing is provided with a housing body facing the outdoor side in the door, and a housing cover assembled to the housing body, the housing cover facing the indoor side in the door, and
the support portion is formed as any one of an attachment hole formed in the housing cover, the attachment hole rotatably supporting the emergency operation member, and an attachment hole formed in the housing body, the attachment hole rotatably supporting the key lock lever.

4. The vehicle door locking device according to claim 2, wherein
the housing is provided with a housing body facing the outdoor side in the door, and a housing cover assembled to the housing body, the housing cover facing the indoor side in the door, and
the support portion is formed as any one of an attachment hole formed in the housing cover, the attachment hole rotatably supporting the emergency operation member, and an attachment hole formed in the housing body, the attachment hole communicating with the guide portion and rotatably supporting the key lock lever.

5. The vehicle door locking device according to claim 3, wherein the emergency operation member has a shaft portion rotatably supported by the attachment hole formed in the housing cover, and an end surface of the shaft portion is exposed outside the housing.

6. The vehicle door locking device according to claim 3, wherein the key lock lever is rotatably supported by the attachment hole of the housing body through an outside locking lever rotatably supported by the attachment hole formed in the housing body, and an end surface of the outside locking lever is exposed outside the housing.

7. The vehicle door locking device according to claim 4, wherein the emergency operation member has a shaft portion rotatably supported by the attachment hole formed in the housing cover, and an end surface of the shaft portion is exposed outside the housing.

8. The vehicle door locking device according to claim 4, wherein the key lock lever is rotatably supported by the attachment hole of the housing body through an outside locking lever rotatably supported by the attachment hole formed in the housing body, and an end surface of the outside locking lever is exposed outside the housing.
